(19) United States
(12) Patent Application Publication
(10) Pub. No.: US 2008/0000817 A1
(43) Pub. Date: Jan. 3, 2008

(54) Sort scheme generation based on bin capacity

(75) Inventors: Paul F. Kostyniuk, Wilmette, IL (US); Steven J. Ksiazek, Schaumburg, IL (US); Steven J. Krejcik, Brookfield, IL (US)

Correspondence Address: MCDERMOTT WILL & EMERY LLP, 600 13TH STREET, N.W., WASHINGTON, DC, 20005-3096, US

(73) Assignee: Bowe Bell + Howell Company

(21) Appl. No.: 11/477,431

(22) Filed: Jun. 30, 2006

(51) Int. Cl. B07C 5/00; G06K 9/00

(52) U.S. Cl. 209/584

(57) ABSTRACT

The subject matter discussed herein relates to a method and system for the processing of mail items with respect to mail item bin capacity. The present method and system ensure that mail piece grouping of larger volumes are assigned to larger capacity bins. As a result, the frequency at which mail sweeps must be conducted during a mail job is minimized, and in turn improves the overall efficiency of a sort operation. In addition, the present method and system enables the high capacity bins to be sorted to with respect to volume at the beginning or end of a mail processing device to accommodate different material handling needs.

### TECHNICAL FIELD

The subject matter discussed herein relates to a method and system for mail item processing, and particularly, a method and system for the processing of mail items with respect to mail item bin capacity.

### BACKGROUND

Document processing facilities often use high speed document processing machines such as sorters, to sort and direct mail items appropriately to one or more mail bins for distribution. The efficiency of a sorter is generally dependent upon various factors, including the rate at which mail items can be fed into a mail transport and subsequently transported along a transport path via a system of mechanized pulleys, levers and rollers, the ability for the address components (e.g., recipient address, ZIP code, bar code) marked upon the mail items to be identified by a reader device for association of each mail piece with a sort scheme managed by a sort scheme computer, and the number of mail items that can be effectively stacked by a mail stacker into one or more mail pockets or bins, in accordance with the specified sort scheme. While numerous other factors may contribute to the overall throughput and sorting ability of a high speed sorter, few things limit the overall effectiveness of a mail processing device greater than machine stoppage during the middle of a mail processing job. In high speed processing devices such as the sorter, complete stoppage of the machine even for brief moments during a job run, can significantly reduce the overall throughput of the device. With this in mind, it is clear that sorting effectiveness is limited when mail bin overflow occurs—a phenomenon wherein the machine is stopped when the number of mail items accumulated within one or more of the mail bins of the mail stacker exceeds the capacity of that particular bin.

A conventional modular arrangement of the elements of a mail bin for which mail overflow may occur is illustrated in FIG. 1. FIG. 1 is a depiction of a mail bin similar to that disclosed in United States Patent Application Pub. No. 2004/0069691 by Svyatsky et al., the disclosure of which is incorporated by reference in its entirety. The mail bin 200 accumulates mail items 210 as they are directed and retrieved from along the transport path 106. A diverter (e.g., driven by a solenoid oriented along the transport path) shifts the transport direction of the mail item into the mail pocket 211—as directed in accordance with the sort scheme/rule relative to that mail item—via a system of tightly wound pulleys. This new transport direction of the mail item is represented in FIG. 1 as the smaller arrow 106b, which leads in the direction of a mail paddle 206. The leading edge of the mail piece is then guided to a side edging 204, and the mail item is placed adjacently to the front plane of the mail paddle 206. As the number of mail items diverted to the mail pocket 211 grows, the mail paddle 206 shifts horizontally along a slide shaft 208 (maintained by a retractable tension device, such as a tension pulley—not shown). One or more sensors may be placed accordingly along the mail bin 200 to detect the movement and/or distance of the mail paddle 206 from an initial position, and consequently, to detect when the mail bin is filled to capacity (overflow) or partially (e.g., ⅔ full).

To prevent mail overflow, periodic sweeps of the one or more mail bins must be conducted by the operator(s) of the sorting device. In other words, the operator(s) must manually remove the sorted mail items collected in the bin in advance of mail overflow occurring and machine stoppage taking place. Obviously, mail sweeping requires increased hands-on attention and manual exertion on the part of the operator(s) to monitor the mail bins lest machine stoppage occurs, especially in instances where few bins are available within the mail stacker relative to the number of mail items to be processed by the sorter. In an effort to minimize the amount of manual intervention required by the operator(s) during a mail run, it is not uncommon to employ the usage of varying sized mail bins. For instance, smaller (standard) capacity bins and larger capacity mail bins can be used. As such the larger capacity mail bins can accommodate a greater volume (number) of mail items given its extended physical length (e.g., up to 300 mail items depending upon the physical characteristics of the mail) versus the smaller capacity mail bins, which are of a lesser length and thus provide lesser mail item accumulation volume (e.g., maximum of 150 mail items given the physical characteristics of the mail). Resultantly, when a plurality of mail items are grouped together for direction to a particular bin—e.g., a grouping of 225 mail items of various grouped 5-digit ZIP codes—the larger capacity bins can accommodate this grouping of mail pieces with no separation of the grouping into other mail bins, therefore requiring less frequency of mail sweeping.

Unfortunately, conventional mail processing devices that employ variable sized mail bins only assign mail to the one or more bins sequentially. In other words, as the mail items are transported through the sorter and the sort scheme is applied, the mail items are generally placed into the pockets in numeric order. With this arrangement, groupings of mail pieces are placed into the bins in ascending to descending sequence, regardless of the relative volume of the groupings of mail pieces to be placed into the mail bins. Larger volume groupings (e.g., greater than 150 mail pieces) may therefore end up being placed into lower volume bins (e.g., capacity up to 150), resulting in more pockets being required to accommodate larger volume groupings, and more mail sweeps. Indeed, the limited usage of higher volume mail bins relative to the volume of the grouping(s) to be processed reduces the overall throughput capacity of the mail processing device.

To overcome the above described challenges, a method and system for ensuring that larger capacity groupings of mail pieces with a common attribute are assigned to larger capacity bins is needed. In this way, the frequency at which mail sweeps must be conducted during a mail job is minimized, and in turn improves the overall efficiency of a sort operation. In addition, a method and system for enabling the high capacity bins to be sorted to with respect to volume at the beginning or end of a mail processing device—thus not sequentially—is needed to accommodate different material handling needs.

### SUMMARY

One aspect presented herein relates to a method for processing mail groupings. The method includes obtaining data information regarding volume of mail pieces to be sorted into a plurality of mail groupings. Each mail grouping includes a plurality of the mail pieces and each mail piece has a delivery point identifier. A bin is assigned for each respective mail grouping based on the volume of the respective mail grouping and at least one delivery point identifier corresponds to the respective mail grouping. The delivery point identifier is detected on each mail piece each mail piece is routed in response to the detected delivery point identifier to a mail bin assigned to the respective grouping corresponding to the delivery point identifier.

In yet another aspect is a method which includes receiving a stream of addressed mail contains a plurality of mail pieces. At least one readable delivery point identifier is detected on each mail piece. A volume of each respective one of a plurality of mail groupings of the stream of mail is determined, with each mail grouping including a portion of the mail pieces. A bin is assigned for each mail grouping based on the volume of the respective mail grouping and each mail piece is routed to the mail bin assigned to the respective mail grouping.

It is also desirable to provide a mail processing system. The system includes machinery for executing one or more mail processing functions. A software based controller is included with the machinery for controlling execution of several processing functions. The controller is capable of obtaining data information regarding volume of mail pieces to be sorted into a plurality of mail groupings. Each mail grouping includes a plurality of the mail pieces with each mail piece having a delivery point identifier. The delivery point identifier is detected on each mail piece each mail piece is routed in response to the detected delivery point identifier to a mail bin assigned to the respective mail grouping corresponding to the delivery point identifier.

In yet another aspect is a method of generating a sort scheme for use in sorting items in a mail stream. The method includes obtaining information including volume of mail items in the mail stream having a first delivery point identifier associated therewith and including volume of mail items in the mail stream having a second delivery point identifier associated therewith. The second delivery point identifier is different from the first delivery point identifier. The obtained information indicates that the volume of mail items having the first delivery point identifier is greater than the volume of mail items having the second delivery point identifier. Based on the indication of greater volume, a first sort bin is assigned to receive mail items having the first delivery point identifier, from among a plurality of sort bins available to receive mail items during a sorting of the mail stream. Also, a second sort bin is assigned to receive mail items having the second delivery point identifier, from among the plurality of sort bins available to receive mail items during the sorting of the mail stream. The first bin sort bin has a larger volume capacity for receiving mail items than the second sort bin.

Additional advantages and aspects of the present subject matter will become readily apparent to those skilled in the art from the following detailed description, wherein embodiments of the present subject matter are shown and described, simply by way of illustration of the best mode contemplated for practicing the present subject matter. As will be described, the present subject matter is capable of other and different embodiments, and its several details are susceptible of modification in various obvious respects, all without departing from the spirit of the present subject matter. Accordingly, the drawings and description are to be regarded as illustrative in nature, and not limitative.

### BRIEF DESCRIPTION OF THE DRAWINGS

The following detailed description of the embodiments of the present subject matter can best be understood when read in conjunction with the following drawings, in which the various features are not necessarily drawn to scale but rather are drawn as to best illustrate the pertinent features, and in which like reference numerals are employed throughout to designate similar features.

FIG. 1 depicts a conventional mail pocket for processing mail pieces of a conventional size;

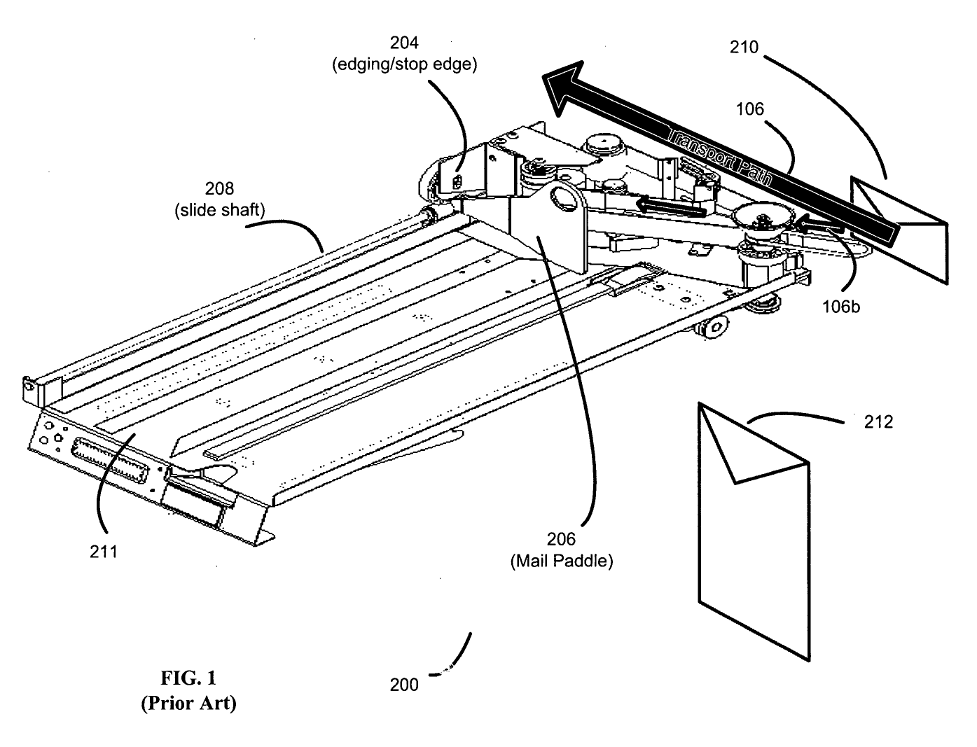

FIG. 2 depicts an exemplary high speed sorter device adapted to process mail items with a mail bin assignment scheme based on bin capacity;

FIG. 3 is flow chart depicting an exemplary mail bin assignment scheme based on bin capacity; and

FIG. 4 depicts an exemplary physical allocation of mail groupings of varying volumes to a plurality of bins based on bin capacity.

### DETAILED DESCRIPTION

As used herein, the term “mail piece” or “mail item” refers to any document having human or machine readable content generated thereon, and particularly that intended for delivery to a given recipient. In the context of a general mailing facility, this may include envelopes, newsletters, newspapers, magazines, post cards, parcels or packages of varying thicknesses (e.g., flat mail), coupon booklets, brochures, and any other like documents. Such documents may or may not be generated for the purposes of being distributed via a distribution channel (e.g., delivery company, postal authority), but rather, may be generated for direct/personal carry, delivery, or internal distribution. When a plurality of such mail items as described above are grouped together (e.g., associated with one another according to a common characteristic or mail item processing rule), this is referred to as a mail group or grouping. Groupings, may include a plurality of mail items having a common ZIP code or range thereof, common internal destination point, or common rules, limitations, or special instructions as defined according to a sort scheme.

Also, as used herein, the phrase document or mail processing system refers to any high speed transport device(s) capable of processing documents at considerably high rates with considerably high precision. Document processing systems may include, but are not limited to, inbound sorting equipment, outbound mail sorting equipment, and even various forms of inserter machines, mail integrity systems, or the like for office, commercial, or industrial settings. A “stacker,” “bin” or “pocket” may refer to any device, typically used as part of a document processing system for receiving, accumulating and/or collecting processed mail pieces. While the foregoing discussion will present the teachings in an exemplary fashion with respect to a conventional sorter device, it will be apparent to those skilled in the art that the teachings may apply to any type of document processing device or system (e.g., inserter, accumulator, etc.) desiring or requiring extended mail accumulation device handling capability.

With this in mind, the following description refers to numerous specific details which are set forth by way of examples to provide a thorough understanding of the relevant teachings. It should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings. It will be appreciated by those versed in the art that the exemplary teachings described herein enable and/or adjust a mail bin assignment scheme—as may be specified according to a sort scheme—such that higher capacity groupings are assigned to higher capacity bins.

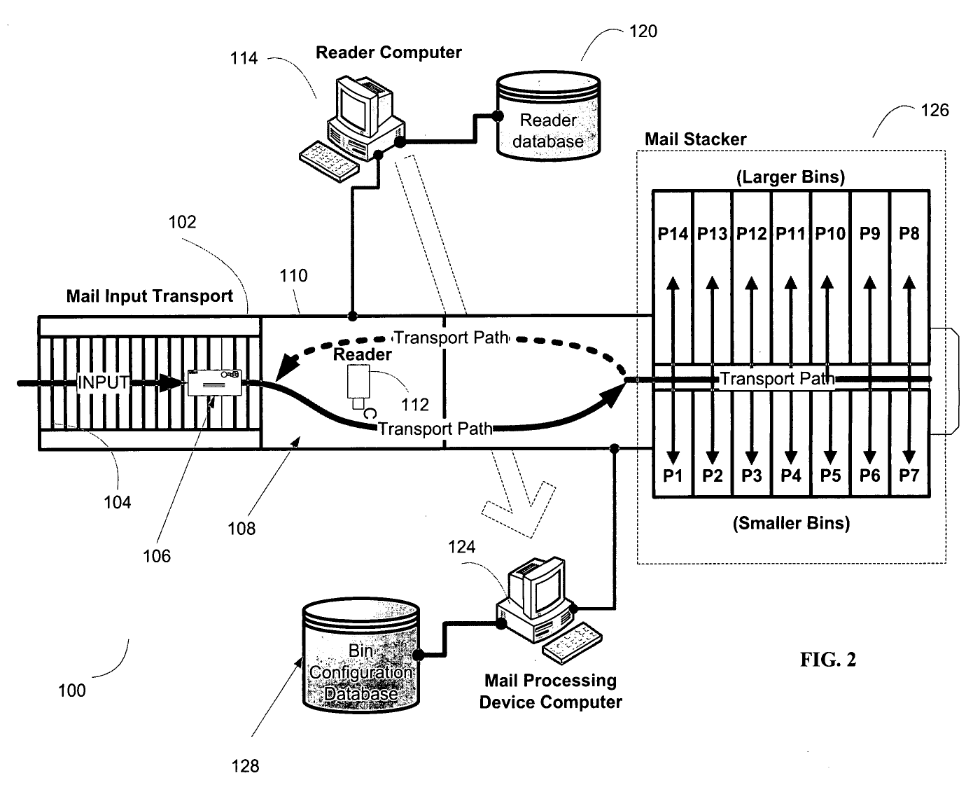

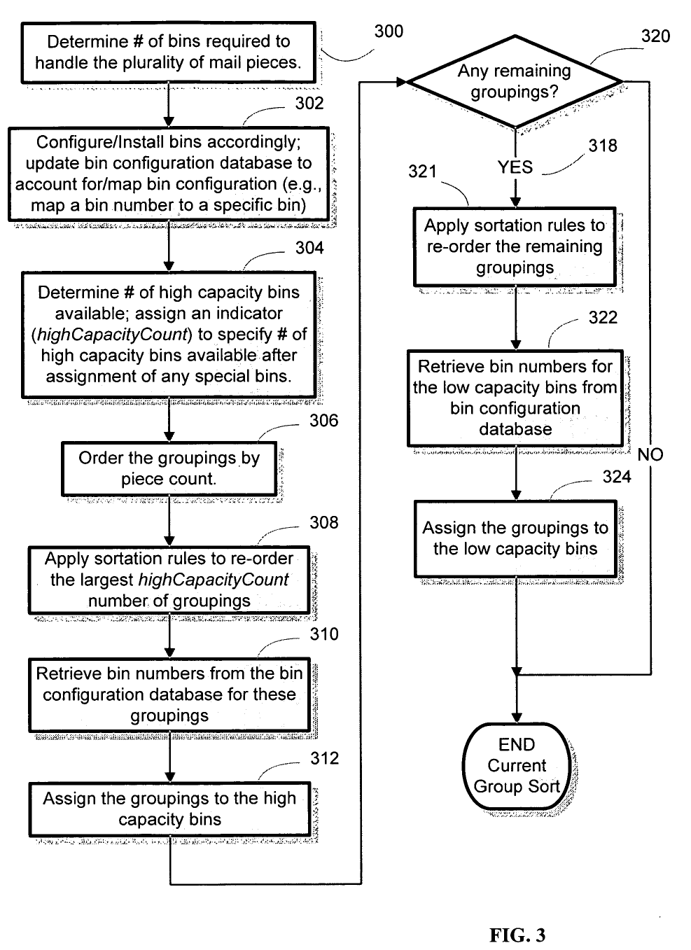

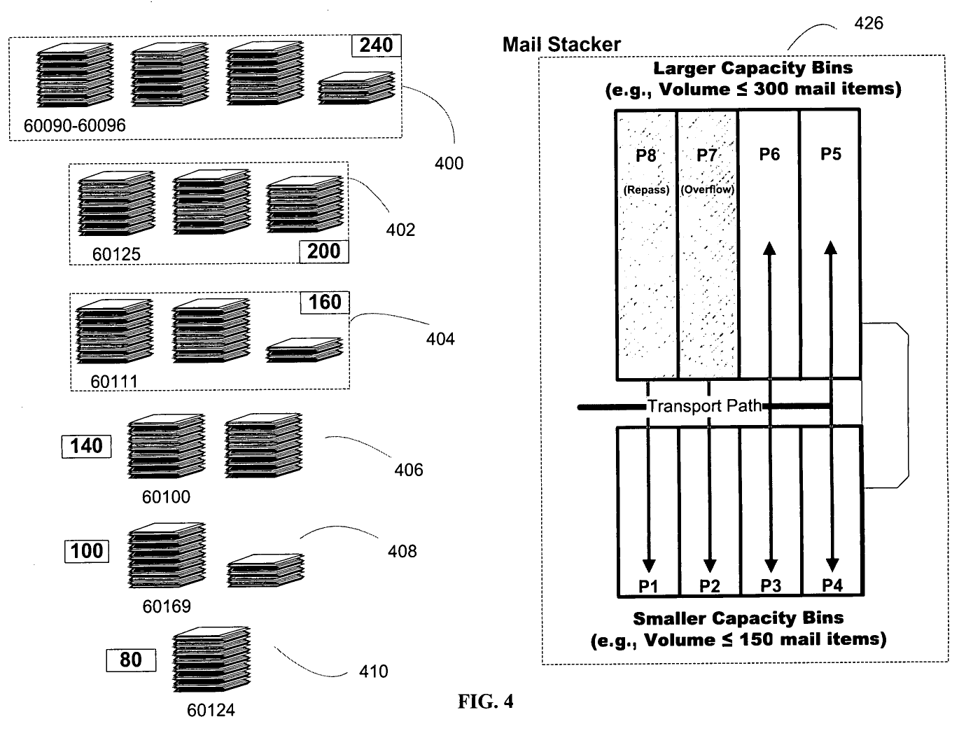

The description now proceeds with a discussion of FIGS. 2 and 3. FIG. 2 is an example of a high speed sorter device adapted to process mail items with a mail bin assignment based on bin capacity. FIG. 3 is a flowchart depicting an exemplary mail bin assignment scheme to be applied in accordance with the teachings herein. The number of bins required to accommodate the mail items to be handled is first determined (step 300). As an example, a sort job requiring the processing of one million mail items with various delivery point identifiers, must be weighed against the number of bins available for the mail processing system 100 (FIG. 2). This determination takes into consideration the availability of a machine to handle the mailing given that machine characteristics may vary—e.g., a mail processing facility having several different types of mail processing devices with different numbers of mail bins. The determination may also take into account the scalability of the high speed document processing machine upon which the sort job is to be processed—e.g., a machine having modular bin attachment capability for adding or subtracting mail bins as needed. Another configuration task may include assignment of special mail bins (FIG. 4), such as those mail bins required for mail re-pass, out of scheme mail, mail overflow, etc. Those skilled in the art will recognize that the configuration of specialized bins such as those stated above, are well known factors to account for in facilitating sort operations and do not limit the scope of the teachings presented herein.

In FIG. 2, a delivery point identifier includes a ZIP code that is marked upon each of the mail items 106 and can be identified by a reader device 112 for routing or sorting of each mail piece in accord with a sort scheme managed by the mail processing device computer 124, and the number of mail items that can be effectively stacked by a mail stacker 126 into one or more mail pockets or bins P1-P14, in accordance with the specified sort scheme. The delivery point identifier, such as a ZIP code may be up to 11 digits long. In addition to ZIP codes, other delivery point identifiers that may be used include the recipient's name or entity name, street name, P.O. Box number, building name, postage or indicia, etc.

A stream of addressed mail can be received and the ZIP code marked upon each of the mail items 106 can be detected by reader device 112. The mail processing system 100 may include a mail input transport component 102, including a grooved belt drive or conveyor belt system 104 for transporting a mail piece 106 and aligning it properly with a transport path 108. The transport path 108 defines the general direction that an incoming mail piece is guided along during its processing by the mail processing system 100. Coupled to the mail input transport component 102, is an image scanning or reader device 110, equipped with an imaging device such as an optical scanner or camera. The reader device 112 scans or images a mail piece 106, or at least the one or more delivery point identifiers on the mail piece, as it is processed by the mail processing system 100 along the transport path 108. Typically, the reader device 112 is placed upstream along the transport path 108 so that the address components can be scanned early on in the processing phase, and subsequently recognized or tracked against recognized data records using optical character recognition technology (OCR). Typical OCR systems include the optical scanner or reader 112 for reading text, and sophisticated software for analyzing images. Alternatively, the OCR system may include a combination of hardware (e.g., specialized circuit boards) and software to recognize characters, or can be executed entirely through software. Those skilled in the art will recognize that various OCR systems may be employed by the reader device 112 for the purpose of recognizing a delivery point identifier residing on the mail piece 106.

The reader device 112 may be controlled by a reader computer 114, which as described above, may or may not execute the OCR utility. Generally, the reader computer 114 is capable of executing various operating system mechanisms that control the behavior of the reader device 112. The reader computer 114 may also include a monitor capable of rendering a user interface to a user of the mail processing system 100 for accessing, interpreting, and depicting the various images scanned by the reader device 112. Coupled to, or resident upon the reader computer 114, is a reader database 120, which contains data records of the plurality of recognized delivery point identifiers that can exist on a mail piece. The reader database 120 can be customized from one enterprise to the next to include an enterprise's commonly known address components. The term enterprise encompasses various sized business organizations, non-profit organizations, educational institutions, etc. When a mail piece is imaged, and OCR technology is used for recognizing the physical address components on the mail piece, the address components may be compared to the data records within the reader database to identify if the mail piece is a match.

Alternatively, information regarding the delivery point identifier marked upon each mail item 106 can be obtained from a database by the mail processing device computer 124. An enterprise may employ inserting devices, sorting devices or other mail processing tools, including a reader device for recognizing the delivery point identifier marked upon each mail piece. The term enterprise encompasses various sized business organizations, non-profit organizations, educational institutions, etc. The database of the particular enterprise stores the delivery point identifier and the mail processing computer 124 can obtain this information from the enterprise database. The enterprise database can be internally or externally located from the facility housing the mail processing system 100.

Once the number of mail bins is determined and/or configured based on the volume of the groupings, the bin assignments are mapped to a bin configuration table (step 302). The bin configuration map/table is used to associate a specific physical bin to a bin number, or slot, within the machine. For example, with respect to an exemplary sorting device of FIG. 2, one or more bins would be mapped to or assigned bin numbers P1 through P14, not including any special assigned bins. Also, depending on the application requirements of the facility or operator of the mail sorting device, the bin configuration bin/map may include physical layout information and bin dimensional data. This bin assignment information is then saved to a bin configuration database 128, and maintained for access by the mail processing device computer 124 of FIG. 2, or other processing device for subsequent access. Such information may be utilized by a sort scheme utility or software program that applies specialized sort rules to mail items, which are further assigned to a specific bin. Likewise, the physical characteristic data (e.g. the dimensions of the mail bins may be utilized for intuitive calculation of the volume capacity of a bin relative to the dimensions of the mail items to be processed (e.g., average mail item thickness). Such capability could be facilitated via the usage of a thickness detection device placed appropriately upstream along the transport path.

When the mail stacker 126 features variable sized mail bins as in FIG. 2, the number of high capacity bins available is determined, corresponding to step 304 in FIG. 3. Once determined, an indicator referred to herein as highCapacityCount is assigned a value equivalent to or representative of the number of high capacity bins available. The highCapacityCount indicator is a processing variable, which may be utilized by the mail processing device computer 124 or sort scheme processing software tool to indicate a count of the number of high capacity bins during a sort pass after the allocation of any special assignment bins. As an example, the highCapacityCount would be assigned a value of ‘7’ indicative of the seven bins P8 through P14 of FIG. 2, that are capable of handling higher mail volume. If, however, one of the larger bins, such as P8 was specially assigned as a mail re-pass bin or other specialized bin, then highCapacityCount would be assigned a value indicative of the six (6) remaining high volume bins (P9 through P14).

As a next step in the exemplary process, the various mail items to be processed are separated into groupings ordered based on piece count (mail item count), corresponding to step 306. In this way, the volume of each grouping is known, and can be organized accordingly (e.g., in ascending or descending order) with respect to the sort scheme. An example of this process as it is applied to a plurality of mail items (albeit a small quantity of mail) is shown in FIG. 4, which depicts several groupings of mail pieces—one or more mail items associated or grouped by a common attribute—ordered in descending order by volume. Practitioners of the art will recognize the order in which the groupings of FIG. 4 are presented is exemplary, and that groupings need not be ordered in a descending manner as shown. Likewise, while depicted as such in FIG. 4, the largest of the larger volume groupings need not necessarily be first to be placed into a bin as opposed to one of a lesser volume. Still further, those skilled in the art will recognize that the ordering process as depicted in FIG. 4 may not necessarily be performed physically, but virtually via a software ordering process. FIG. 4 is meant to be exemplary, and in no way limits the scope of the teachings herein.

In FIG. 4, the highest volume grouping 400 consists of 240 mail items having common 5-digit ZIP codes ranging from 60090 to 60096, while the smallest volume grouping 410 has 80 mail items of common ZIP code 60124. While various means of creating and/or ordering the groupings may be applied, it is not uncommon to group a range of ZIP codes into a single grouping, such as in accordance with postal authority (e.g., United States Postal Service) address rules. It is noted that a range or number of ZIP codes can be assigned to each bin and not a single ZIP code to one bin. As an example, all items with a ZIP code starting with a 0 digit can be assigned to one bin and all ZIP codes starting with a 1 digit can be assigned to another bins. Ultimately, the groupings are to be directed to the mail stacker 426 component of the sorting device having differing sized bin capacities, to accommodate the differing sized groupings (e.g., volume greater than or equal to 150, or less than 150 mail items). In the case of FIG. 4, the mail stacker 426 employs eight bins, four of which are larger sized capacity bins P5-P8, and the other four being smaller in size P1-P4.

Once the groupings are ordered by volume (step 306), the mail processing device computer 124 applies the appropriate sort scheme to the number of groupings equivalent to the current highCapacityCount value (step 308). Typically, sort rules are applied via the usage of a sort scheme specified by the sort scheme utility or software tool. Alternatively, depending upon the mail processing requirements, the sort rules may be applied at an earlier time than specified in the exemplary diagram. Once the sort scheme is applied, the appropriate bin assignment data specified within the sort scheme—e.g., the bin numbers—for the newly re-ordered mail groupings is retrieved from the bin configuration database (step 310), and a highCapacityCount number of larger mail the groupings are assigned accordingly to the high capacity bins (step 312) P5 through P8. As will be obvious to those experienced in the art, the exemplary procedure disclosed herein ensures that volume is accounted for early within the sort process, to affect the ultimate bin assignment and usage throughout the mail processing cycle.

Subsequent to the assignment of the highCapacityCount groupings to the larger capacity bins, if there are still groupings remaining to be processed (step 318), the remaining groupings are then assigned to the smaller capacity bins. More specifically, sort rules are applied to these remaining groupings (step 321) in accordance with the established sort scheme, and the appropriate bin assignment data is retrieved from the bin configuration database (step 322). Once retrieved, the groupings are assigned to the low capacity bins, corresponding to step 324. This process is then repeated for as long as there are remaining groupings requiring sorting (step 314) during the subsequent mail passes. When all of the groupings are assigned, the sort process ends (step 320).

To further expound upon the exemplary teachings presented above, a more thorough discussion of FIG. 4 as it relates to the exemplary teachings depicted in FIG. 3 is described. The number of highCapacityCount groupings in this example is two, namely P5 and P6, while P7 and P8 are specially assigned for repass and mail overflow, respectively. In this example, there are two larger capacity bins available, however, there are three larger volume groupings, namely groupings 400, 402 and 404. The mail items that comprise the larger volume groupings possess physical characteristics (e.g., mail item thickness) and quantity that makes them better suited for direction to a larger capacity bin. Grouping 400, being the largest current grouping within the mailing, is set initially as the first highCapacityCount grouping (highCapacityCount=2), followed by grouping 402 as highCapacityCount=2. With no consideration for maximizing the usage of the high capacity bins P5 and P6 as the teachings suggest, grouping 400, 402 and 404 would be directed firstly to the smaller capacity bins P1 through P4. Assuming the smaller capacity bins P1 through P4 accommodate a maximum of 150 mail items at a time, groupings 400, 402, 404 and 406 would be assigned to mail bins P1, P2, P3 and P4 respectively in sequential ascending order. Consequently, the high volume of groupings 400, 402 and 404, each in excess of the 150 mail item limit of the smaller capacity bins, necessitates more mail sweeps to be conducted per mail bin. Only grouping 140, as assigned to mail bin P4 would require a single mail sweep, while the others would require at least two sweeps. Still further, the subsequent groupings 406 and 408 would be assigned to the larger capacity bins P5 and P6; an obvious misusage of the larger sized bins relative to such small sized groupings. Grouping 410 would be need to be passed through the machine again, or placed in the overflow bin P7.

In contrast, employment of the exemplary teachings would call for the current highCapacityCount groupings to be assigned to the larger capacity bins first. In this case, the larger capacity bins P5 and P6 are capable of accommodating volumes of up to 300 mail items. Therefore, the two largest groupings 400 and 402 would be applied in sequential ascending order to P5 and P6 respectively. The remaining groupings, 404, 406, 408 and 410 are then assigned to the smaller capacity bins P1 through P4 respectively. With this configuration and assignment process in place, the largest mail groupings are assigned to the larger sized bins, resulting in fewer overall mail sweeps. Alternatively, the bins could be assigned in a specialized manner, such as towards the beginning or end of a mail processing machine, or at a lower or upper mail stacker level (e.g. for a multi-tiered mail stacker device), to accommodate the differing material handling needs of a facility.

Those skilled in the art will appreciate that the present teachings reduce the frequency at which mail sweeps must be conducted during a mail job, and in turn, improves the overall efficiency of a sort operation. In addition, the present teachings present a means for enabling the high capacity bins to be sorted to with respect to volume at the beginning or end of a mail processing device. A further teaching within the context of this disclosure contemplates the usage of a visual indicator (e.g., a user interface) for specifying the relative bin sizes of the mail stacker. Such an interface could be used in conjunction with the sort scheme utility or software program, and could provide extra added functionality, such as a depiction of the physical bin dimensions of the various bins, mouse click enabled selection of bins for sequential order, and non bin volume conscious sorting versus bin volume conscious sorting.

The exemplary mail processing computer 124 of the mail processing system 100 may include a central processing unit (CPU), memories, and an interconnect bus. The CPU may contain a single microprocessor, or may contain a plurality of microprocessors for configuring the mail processing computer 124 as a multi-processor system. The memories include a main memory, a read only memory, and mass storage devices such as various disk drives, tape drives, etc. The main memory typically includes dynamic random access memory (DRAM) and high-speed cache memory. In operation, the main memory stores at least portions of instructions for execution by the CPU and data for processing in accord with the executed instructions.

The bin configuration database 128 may include one or more magnetic disk or tape drives or optical disk drives, for storing data and instructions for use by the CPU of the mail processing computer 124. For a workstation PC, for example, at least one mass storage system 208 in the form of a disk drive or tape drive, stores the operating system and application software as well as a data file. The bin configuration database 128 may also include one or more drives for various portable media, such as a floppy disk, a compact disc read only memory (CD-ROM or DVD-ROM), or an integrated circuit non-volatile memory adapter (i.e. PC-MCIA adapter) to input and output data and code to and from the mail processing device computer 124.

The mail processing device computer 124 also includes one or more input/output interfaces for communications, shown by way of example as an interface for data communications via a network or direct line connection. The interface may be a modem, an Ethernet card or any other appropriate data communications device. The physical communication links may be optical, wired, or wireless. The network or discrete interface may further connect to various electrical components of other document processing devices to transmit instructions and receive information for control thereof (e.g., print file information stored locally or as received remotely for enabling network printing). The network shall include any type of communication implementation for receiving and transmitting information to and from components of the mail processing system 100 and components external to and/or remote from the mail processing system 100.

The mail processing device computer 124 may further include appropriate input/output ports for interconnection with a display and a keyboard serving as the respective user interface. For example, the mail processing device computer 124 may include a graphics subsystem to drive the output display. The output display may include a cathode ray tube (CRT) display or liquid crystal display (LCD). Although not shown, the PC type system typically would include a port for connection to a printer. The input control devices for such an implementation of the system would include the keyboard for inputting alphanumeric and other key information. The input control devices may further include a cursor control device (not shown), such as a mouse, a trackball, a touchpad, stylus, or cursor direction keys. The links of the peripherals to the system may be wired connections or use wireless communications.

The mail processing device computer 124 shown and discussed is an example of a platform supporting processing and control functions of the mail processing system described herein. The control processing functions and the sort scheme capabilities discussed herein may reside on a single computer system, or two separate systems; or one or both of these functions may be distributed across a number of computers. Likewise, the control processing function and sort scheme operations may be implemented as one or more microprocessors or executable modules (e.g., firmware) that reside and operate upon the mail processing device computer 124.

The software functionalities of the mail processing device computer 124 involve programming, including executable code as well as associated stored data. Software code is executable by the mail processing device computer 124 that functions the system controller. In operation, the code and possibly the associated data records are stored within the mail processing device computer 124. At other times, however, the software may be stored at other locations and/or transported for loading into the appropriate general-purpose computer system. Hence, the embodiments involve one or more software products in the form of one or more modules of code carried by at least one machine-readable medium. Execution of such code by a processor of the computer platform enables the platform to implement the sort scheme and related document processing control functions, in essentially the manner performed in the embodiments discussed and illustrated herein.

As used herein, terms such as computer or machine “readable medium” refer to any medium bearing the code, algorithms, routines or instruction(s) that may participate in the functions of a processor and/or bearing one or more of the data files to facilitate dynamic labeling. Such a medium may take many forms, including but not limited to, non-volatile media, volatile media, and transmission media. Non-volatile media include, for example, optical or magnetic disks, such as any of the storage devices in any computer(s) operating as one of the system control platform, discussed above. Volatile media include dynamic memory, such as main memory of such a computer platform. Physical transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution and/or in carrying one or more data files to a computer or to a printer.

In the previous description, numerous specific details are set forth, such as specific materials, structures, processes, etc., in order to provide a better understanding of the present subject matter. However, the present subject matter can be practiced without resorting to the details specifically set forth herein. In other instances, well-known processing techniques and structures have not been described in order not to unnecessarily obscure the present subject matter.

Only the preferred embodiments of the present subject matter and but a few examples of its versatility are shown and described in the present disclosure. It is to be understood that the present subject matter is capable of use in various other combinations and environments and is susceptible of changes and/or modifications within the scope of the inventive concept as expressed herein.

What is claimed is:

1. A method for processing mail groupings, comprising the steps of:
obtaining data information regarding volume of mail pieces to be sorted into a plurality of mail groupings, each mail grouping comprising a plurality of the mail pieces and each mail piece having a delivery point identifier;
assigning a bin for each respective mail grouping based on the volume of the respective mail grouping and at least one delivery point identifier corresponding to the respective mail grouping;
detecting the delivery point identifier on each mail piece; and
routing each mail piece in response to the detected delivery point identifier to a mail bin assigned to the respective grouping corresponding to the delivery point identifier.

2. The method of claim 1, wherein the assigning step comprises:
assigning larger volume mail groupings to large capacity bins; and
assigning smaller volume mail groupings to small capacity bins.

3. The method of claim 2, wherein the routing step is performed via a mail sorter device, and the large and small capacity bins are bins of the mail sorter device.

4. The method of claim 1, wherein the obtaining step comprises:
receiving the data information from a database.

5. The method of claim 1, wherein the delivery point identifier comprises a postal ZIP code.

6. A computer system programmed to implement the method of claim 1.

7. A software product comprising executable instructions for programming a computer to implement the method of claim 1, and a machine-readable medium bearing the instructions.

8. A method for processing mail groupings, comprising the steps of:
receiving a stream of addressed mail, the addressed mail comprising a plurality of mail pieces;
detecting at least one readable delivery point identifier on each mail piece;
determining a volume of each respective one of a plurality of mail groupings of the stream of mail, each mail grouping comprising a portion of the plurality of the mail pieces;
assigning a bin for each mail grouping based on the volume of the respective mail grouping; and
routing each mail piece for each respective one of the mail groupings to the mail bin assigned to the respective grouping.

9. The method of claim 8, wherein the delivery point identifier comprises a postal ZIP code.

10. The method of claim 8, wherein the assigning step comprises:
assigning larger volume mail groupings to large capacity bins; and
assigning smaller volume mail groupings to small capacity bins.

11. The method of claim 8, wherein the routing step is performed via a mail sorter device, and the large and small capacity bins are bins of the mail sorter device.

12. The method of claim 8, wherein the delivery point identifier comprises a postal ZIP code.

13. The method of claim 12, wherein the detecting step comprises detecting the delivery point identifier with a reader device.

14. The method of claim 8, wherein the determining step is determined by sorting.

15. A computer system programmed to implement the method of claim 8.

16. A software product comprising executable instructions for programming a computer to implement the method of claim 8, and a machine-readable medium bearing the instructions.

17. A mail processing system comprising:
machinery for executing one or more mail processing functions;
a software based controller for the machinery for controlling execution of at least the following processing functions:
obtaining data information regarding volume of mail pieces to be sorted into a plurality of mail groupings, each mail grouping comprising a plurality of the mail pieces and each mail piece having a delivery point identifier;
assigning a bin for each respective mail grouping based on the volume of the respective mail grouping and at least one delivery point identifier corresponding to the respective mail grouping;
detecting the delivery point identifier on each mail piece; and
routing each mail piece in response to the detected delivery point identifier to a mail bin assigned to the respective mail grouping corresponding to the delivery point identifier.

18. The mail processing system of claim 17, wherein the machinery comprises a mail sorting device.

19. The mail processing system of claim 17, wherein the software based controller further comprises a user interface.

20. The mail processing system of claim 19, wherein the user interface provides a visual indication of bin size.

21. The mail processing system of claim 20, wherein the user interface allows a user to view or edit details regarding the assigning step.

22. A method of generating a sort scheme for use in sorting items in a mail stream, comprising:
obtaining information including volume of mail items in the mail stream having a first delivery point identifier associated therewith and including volume of mail items in the mail stream having a second delivery point identifier associated therewith, the second delivery point identifier being different from the first delivery point identifier,
wherein the obtained information indicates that the volume of mail items having the first delivery point identifier is greater than the volume of mail items having the second delivery point identifier; and
based on the indication of greater volume:
(a) assigning a first sort bin to receive mail items having the first delivery point identifier, from among a plurality of sort bins available to receive mail items during a sorting of the mail stream; and
(b) assigning a second sort bin to receive mail items having the second delivery point identifier, from among the plurality of sort bins available to receive mail items during the sorting of the mail stream,
wherein the first bin sort bin has a larger volume capacity for receiving mail items than the second sort bin.

23. The method of claim 22, wherein the first delivery point identifier comprises a first postal ZIP code, and the second delivery point identifier comprises a second postal ZIP code.

24. The method of claim 22, wherein the obtaining step comprises:
obtaining the information including volume of mail items from a database.

25. A computer system programmed to implement the method of claim 22.

26. A software product comprising executable instructions for programming a computer to implement the method of claim 22, and a machine-readable medium bearing the instructions.

27. The method of claim 11, wherein large capacity bins are positioned at a front end of the mail sorter device ahead of the small capacity bins.

28. The method of claim 11, wherein large capacity bins are positioned at a back end of the mail sorter device after the small capacity bins.

29. The method of claim 18, wherein the assigning step comprises:
assigning larger volume mail groupings to large capacity bins; and
assigning smaller volume mail groupings to small capacity bins.

30. The method of claim 29, wherein the large capacity bins are positioned at a front end of the mail sorter device ahead of the small capacity bins.

31. The method of claim 29, wherein large capacity bins are positioned at a back end of the mail sorter device after the small capacity bins.

32. The method of claim 8, wherein the delivery point identifier comprises a P.O. box, recipient's name, mail stop or department.

33. The method of claim 1, wherein the delivery point identifier comprises a P.O. box, recipient's name, mail stop or department.

34. The method of claim 11, wherein large capacity bins are positioned at an upper level of the mail sorter device above the small capacity bins.

35. The method of claim 11, wherein large capacity bins are positioned at a lower level of the mail sorter device below the small capacity bins.
